(19) United States
(12) Patent Application Publication
(10) Pub. No.: US 2021/0369028 A1
(43) Pub. Date: Dec. 2, 2021

(54) DRINKING UTENSIL

(71) Applicant: Everywhere Joe, LLC, Lake Forest, IL (US)

(72) Inventors: Joseph Charles Jones Risberg, St. Paul, MN (US); Nicholas Conrad Yehle, Lake Forest, IL (US)

(21) Appl. No.: 17/335,905

(22) Filed: Jun. 1, 2021

Related U.S. Application Data
(60) Provisional application No. 63/102,143, filed on Jun. 1, 2020.
(60) Provisional application No. 63/160,249, filed on Mar. 12, 2021.

(51) Int. Cl. A47G 21/18; B01D 35/30

(52) U.S. Cl. CPC A47G 21/188; B01D 2201/4092; B01D 35/30

(57) ABSTRACT

A drinking utensil having a longitudinal axis has an elongate body having a first end and an opposing second end spaced from the first end along the longitudinal axis. The elongate body defines a lumen therethrough from the first end to the second end. A filter body can be coupled to the first end of the elongate body. The filter body has a housing defining at least one side opening and a top opening that is in communication with the lumen of the elongate body. The filter body has a filter (e.g., a mesh filter) extending across and covering the at least one side opening of the housing.

### CROSS-REFERENCE TO RELATED APPLICATIONS

This application is related to U.S. Provisional Application No. 63/102,143, filed Jun. 1, 2020, and U.S. Provisional Application No. 63/160,249, filed Mar. 12, 2021 the entirety of each of which is hereby incorporated by reference herein.

### FIELD

This application relates to devices, systems, and methods for preparing and consuming turbid beverages, such as, for example and without limitation, coffee beverages within which solid material can be suspended.

### BACKGROUND

Conventional methods for preparing turbid beverages such as coffee include use of a French press, automatic or manual drip machines, and pod-based systems. In such systems, coffee is made by pushing or gravity-feeding hot water through coffee grounds. The coffee grounds are filtered from the liquid coffee, thereby leaving liquid coffee generally free of the solid coffee grounds so that the liquid coffee can be consumed without coffee grounds being ingested.

However, these conventional methods have drawbacks. For example, the methods can be time-consuming and expensive. Additionally, the methods can have a negative impact on both the environment and the health of users. More generally, the methods can be inconvenient for any individual consumer depending on a variety of subjective, situational factors. Further, because the systems for performing these methods are not portable, users are unable to produce high-quality beverages outside a kitchen space.

### SUMMARY

Described herein, in various aspects, is a drinking utensil having a longitudinal axis. The drinking utensil can comprise an elongate body having a first end and an opposing second end spaced from the first end along the longitudinal axis. The elongate body can define a lumen therethrough from the first end to the second end. A filter body can be coupled to the first end of the elongate body. The filter body can comprise a housing defining at least one side opening and a top opening that is in communication with the lumen of the elongate body. The filter body can further comprise a filter extending across and covering the at least one side opening of the housing.

Additional advantages of the disclosed apparatuses, systems, and methods will be set forth in part in the description that follows, and in part will be obvious from the description, or may be learned by practice of the invention. The advantages of the disclosed apparatuses, systems, and methods will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the disclosed apparatuses, systems, and methods will become more apparent in the detailed description in which reference is made to the appended drawings wherein:

FIG. 1 is a perspective bottom end view of a drinking utensil in accordance with embodiments disclosed herein.

FIG. 2 is a side view of the drinking utensil of FIG. 1.

FIG. 3 is a front view of the drinking utensil of FIG. 1.

FIG. 4 is a rear view of the drinking utensil of FIG. 1.

FIG. 5 is a top view of the drinking utensil of FIG. 1.

FIG. 6 is a bottom view of the drinking utensil of FIG. 1.

FIG. 7 is a top end perspective view of a filter body of the drinking utensil of FIG. 1.

FIG. 8 is a bottom end perspective view of an elongate body of the drinking utensil of FIG. 1.

FIG. 9 is a diagram showing a top opening of the drinking utensil of FIG. 1.

FIG. 10 is a perspective view of a filter body of a drinking utensil having openings with chamfered edge.

FIG. 11 is a sectional view of the filter body of FIG. 10.

FIG. 12 is a schematic diagram of a portion of an exemplary drinking utensil as disclosed herein.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” include plural referents unless the context clearly dictates otherwise. For example, use of the term “an opening” can refer to one or more of such openings, and so forth.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of” For example, “at least one of A, B and C” explicitly includes only A, only B, only C, and combinations of each.

Ranges can be expressed herein as from “about” or “approximately” one particular value, and/or to “about” or “approximately” another particular value. When such a range is expressed, another aspect includes from the one particular value and/or to the other particular value. Similarly, when values are expressed as approximations, by use of the antecedent “about” or “approximately,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” “approximately,” or “generally,” it is contemplated that values within up to 15%, up to 10%, up to 5%, or up to 1% (above or below) of the particularly stated value can be included within the scope of those aspects. Similarly, in some optional aspects, “generally cylindrical” can mean within up to 15%, up to 10%, up to 5%, or up to 1% variation between maximum and minimum radial outer diameters. Further, in some optional aspects, “generally parallel” can mean within up to 15 degrees, up to 10 degrees, up to 5 degrees, or up to 1 degrees of being parallel.

The word “or” as used herein means any one member of a particular list and also includes any combination of members of that list.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

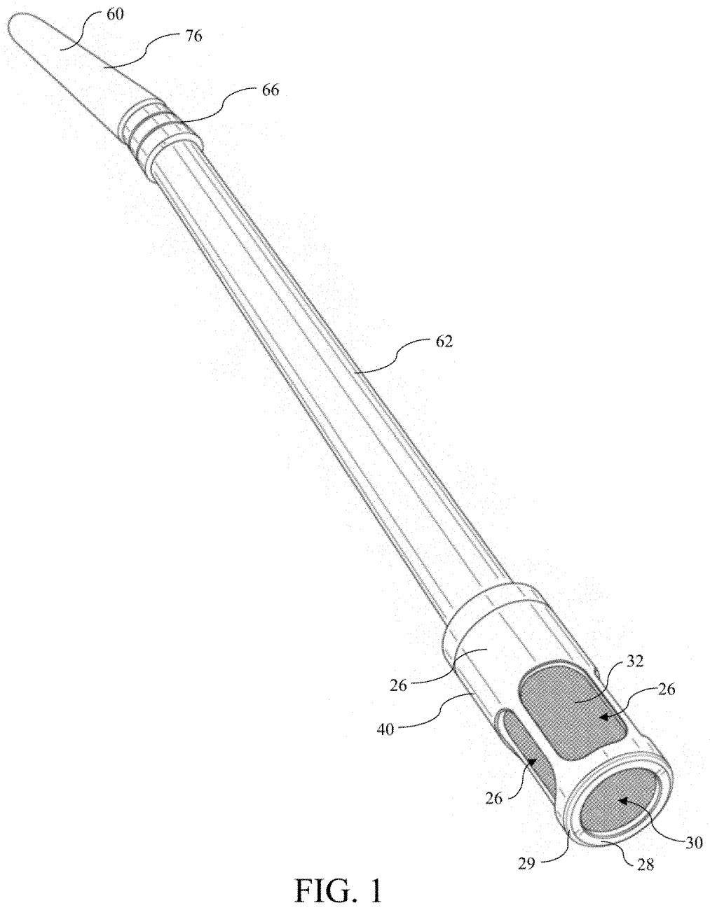

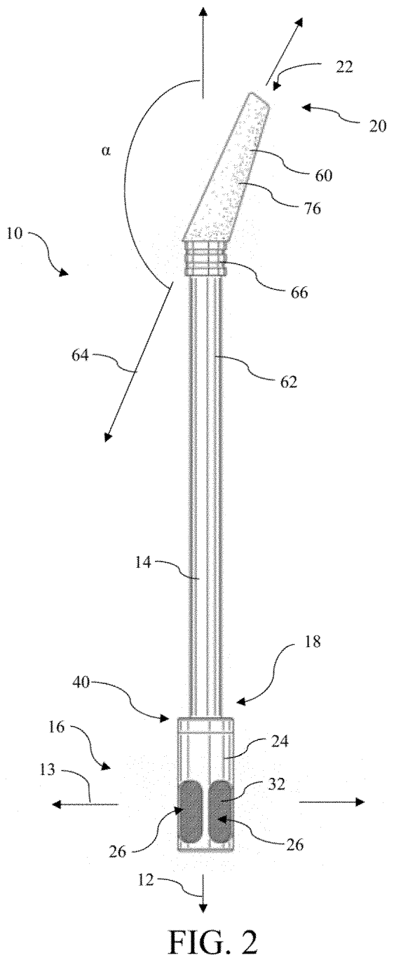

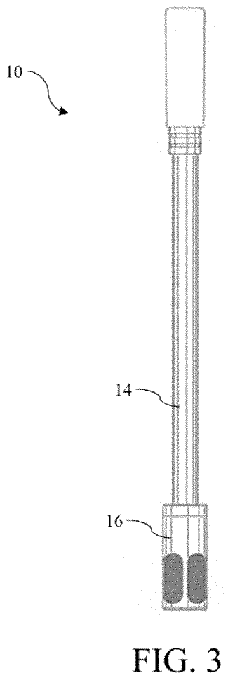

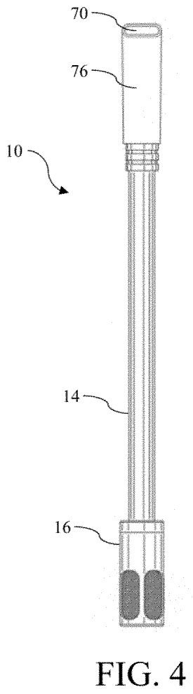

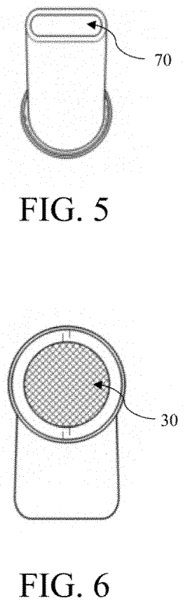

Disclosed herein, with reference to FIGS. 1-2 is a drinking utensil 10 having a longitudinal axis 12. The drinking utensil 10 can comprise an elongate body 14 and a filter body 16. The elongate body 14 can have a first end 18, a second end 20 opposite the first end 18, with the second end being spaced from the first end along the longitudinal axis 12. The elongate body 14 can define a lumen 22 therethrough from the first end 18 to the second end 20.

The filter body 16 can comprise a housing 24. The housing 24 can define at least one top opening 26 in communication with the lumen 22 of the elongate body 14. The housing 24 can further comprise one or more side openings 26. Optionally, the housing 24 can have a single side opening 26. In further aspects, the housing can have a plurality of side openings 26 (e.g., optionally, four side openings). The plurality of side openings 26 can be equally circumferentially spaced around the longitudinal axis 12. Alternatively, it is contemplated that the plurality of side openings 26 can have an unequal circumferential spacing. Optionally, the one or more side openings 26 can be elongate along the longitudinal axis 12. For example, in some aspects, each side opening can have an axial dimension (measured along longitudinal axis 12) and a transverse dimension (measured along an axis that is perpendicular to longitudinal axis 12) that is less than the axial dimension. For example, optionally, the one or more side openings 26 can have an axial dimension of between 12 and 18 mm (e.g., 15 mm, or about 15 mm). In some optional aspects, the side openings can have a transverse dimension of between 6 and 10 mm (e.g., 8.5 mm or about 8.5 mm). In some aspects, it is contemplated that each side opening can have the same or approximately the same dimensions (and area). However, in other aspects, it is contemplated that at least one opening of the plurality of side openings can have dimensions (optionally, an area) that are different than those of at least one other side opening. In some optional aspects, the side openings can be generally rectangular, having rounded corners, as illustrated.

In exemplary aspects, the elongate body and the housing of the filter body can comprise steel (e.g., stainless steel). However, it is contemplated that other materials capable of performing as disclosed herein can be used. Optionally, the elongate body and/or the housing of the filter body can comprise a coating (e.g., a coating that inhibits oxidation).

In some aspects the housing 24 can have a bottom end 28 that defines one or more bottom openings 30. Optionally, the bottom opening 30 can have a diameter of between 8 and 12 mm (e.g., 10 mm or about 10 mm).

The filter body 16 can further comprise a filter 32 (e.g., mesh filter) that extends across and covers each of the one or more side openings 26. The filter 32 can further extend across the bottom opening(s) 30. As used herein, the term “extends across and covers” is intended to encompass any structural arrangement in which liquid cannot travel through the side opening without passing through a portion of the filter. Optionally the filter 32 can be a single structure (e.g., sheet) of mesh material. In further aspects, the filter can comprise a plurality of separate sheets of mesh material that cooperate to cover each of the side openings 26.

In some aspects, the filter can have a mesh number ranging from about 80 mesh to about 240 mesh, or, optionally, from about 100 mesh to about 150 mesh. In further aspects, the filter can have a mesh number of about 100 mesh. It is contemplated that too low of a mesh number can allow too many, or too large of, coffee grounds (or other steeped material) to pass therethrough, thereby diminishing the drinking experience. It is further contemplated that too high of a mesh number can inhibit flow and can get clogged, as well as lack sufficient durability.

In some aspects, the one or more side openings 26 and the one or more bottom openings 30 can cooperate (i.e., the areas of the openings can be added together) to define a combined filtered inlet area of at least 300 square millimeters, or at least 325 square millimeters, or at least 350 square millimeters, or at least 400 square millimeters. In this way, sufficient flow can be drawn therethrough.

It is contemplated that the distance from the bottom end 28 of the housing 24 to the farthest portion of the one more side openings 26 (e.g., at the maximum axial dimension of the side opening) corresponds to the depth of liquid (with the bottom end 28 against a bottom surface of a container) at which air will be drawn through the side opening(s). Thus, the user will have difficulty drawing the liquid (e.g., coffee) through the dinking utensil when the liquid level drops below this distance. Therefore, it can be desirable to minimize this distance to enable the user to obtain the most liquid from the container through the drinking utensil. Accordingly, in some optional aspects, no portion of any of the one or more side openings 26 can extend farther than 30 mm, or no farther 25 mm, or no farther 23 mm, or no farther than 19 mm, from the bottom surface 28 of the housing 24.

In some optional aspects, the housing 24 can have a generally cylindrical shape that defines a circumferential surface 40, which can have a central axis that is coaxial with the longitudinal axis. However, it is contemplated that the housing can be provided in other shapes. In some optional aspects, the housing 24 can have a length along the longitudinal axis 12 and a width (optionally, diameter) along an axis 13 that is transverse to the longitudinal axis 12. In some aspects, the length of the housing 24 can be greater than the width (optionally, diameter) of the housing. Optionally the length of the housing can be at least 1.5 times or at least two times the width of the housing 24. It is contemplated that having a housing 24 that is elongate along the longitudinal axis 12 can enable the user to tilt the drinking utensil (i.e., change the angle of the longitudinal axis 12 relative to the orientation of the container) with the bottom surface 28 against the bottom of the container without substantially increasing the distance between the bottom of the container and the farthest end of any one of the side openings 26. Still further, in some aspects, the generally cylindrical circumferential surface 40 and the bottom surface 28 of the housing 24 can intersect at a bottom edge 29 having a radius of curvature of at least 1 mm or at least 2 mm or at least 3 mm. In exemplary aspects, the radius of curvature can be less than 10 mm or less than 5 mm. This radius of curvature can further serve to maintain the side openings 26 as low as possible within the container as the drinking utensil is tilted therein.

Optionally, the filter 32 can be slidably received within the housing (e.g., for cleaning or replacement). For example, it is contemplated that the filter 32 can be biased outwardly such that it engages inner surfaces of the filter body when received therein. In exemplary aspects, it is contemplated that the filter 32 can be securely received within the housing without the use of a fastener or welding.

In further aspects, the filter 32 (e.g., mesh filter) can be fixedly coupled to the housing 24. For example, in some aspects, the filter 32 can be welded to the housing 24. In some aspects, the filter 32 can define at least one seam (forming a space between portions of the filter when the filter is in a use position, or forming an aesthetically unappealing line of overlapping portions of the filter material). As described herein, the housing 24 can define a plurality of circumferentially spaced side openings 26 that cooperate to define respective longitudinally extending sections 50 therebetween adjacent (sequential) side openings. As used herein, the term “adjacent” refers to respective openings that are sequentially positioned moving along the circumference of the housing 24. In exemplary aspects, the longitudinally extending sections 50 can extend parallel or generally parallel to the longitudinal axis. It is contemplated that the filter 32 can be coupled to the housing 24 (e.g., via welding) with the seam (or seams) hidden behind one of the longitudinally extending sections 50. By positioning the seams behind the longitudinally extending sections 50, it is contemplated that each side opening 26 can be consistently covered by the filter (e.g., mesh) material, without any void area being formed by a seam, and without any aesthetically unappealing lines visible from the exterior.

In one example, the filter 32 can comprise first and second sheets. The first sheet can be a circular or generally circular sheet, while the second sheet can be a rectangular or generally rectangular sheet. The first sheet can be positioned across a bottom opening 30, while the second sheet can be rolled into a cylindrical or generally cylindrical configuration and positioned within the filter body, with the filter material extending across each side opening. Optionally, adjoining ends of the rectangular section of mesh material can be coupled together to maintain the side portion in rolled form. For example, the adjoining ends of the side portion can overlap, and the overlapping portions can be welded (or otherwise coupled) together to form an axially extending seam. Optionally, the bottom portion of the filter 32 can be welded to, or otherwise coupled to, the side portion. For example, in exemplary, optional aspects, an outer edge of the bottom portion of the filter can be folded upwardly around an outer circumference of the side portion of the filter (when rolled into cylindrical form) so that portions of the bottom portion and side portion of the filter overlap, and the overlapping portions can be welded together. In some optional aspects, at least one of the first and second sheets can be welded to one or more surfaces of the filter body, thereby securing the first and second sheets across the openings defined by the filter body. Alternatively, rather than using welding, it is contemplated that fasteners and/or adhesives can be used to secure the filter material to the filter body.

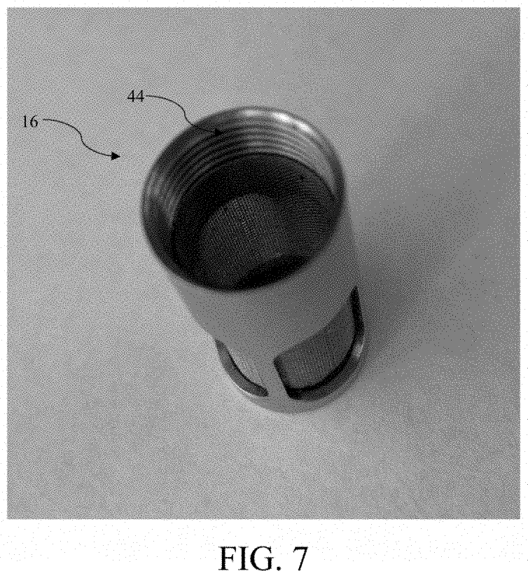

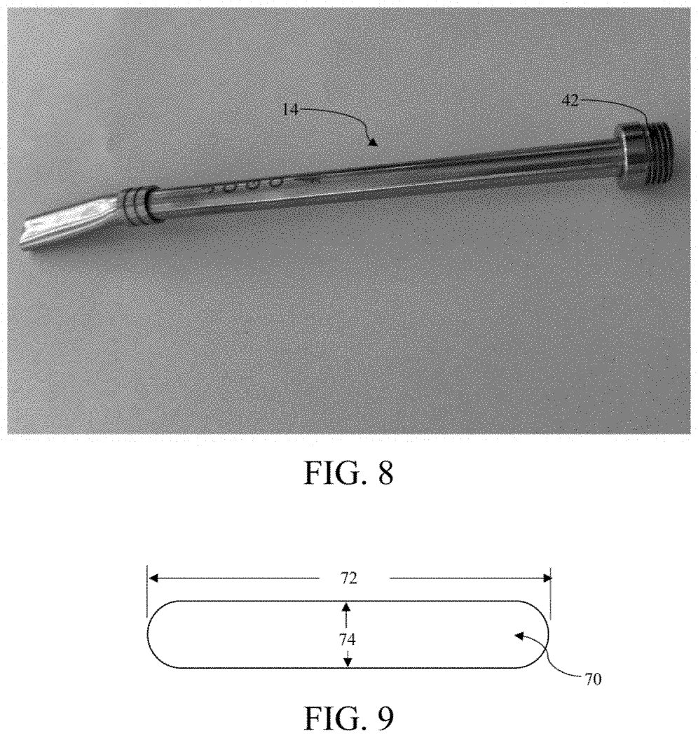

Referring to FIGS. 7-8, the elongate body 14 can couple to the filter body 16 via a threaded coupling 40. For example, the elongate body 14 can comprise one or more male threads 42, and the filter body 16 can comprise one or more female threads 44. However, in other aspects, it is contemplated that the elongate body 14 can comprise one or more female threads, while the filter body has an exterior surface that defines one or more male threads. It is contemplated that the threaded coupling can allow the drinking utensil 10 to be dismantled for cleaning. Moreover, the threaded coupling 40 can allow for thousands of iterations of decoupling and recoupling without forming leaks between the elongate body 14 and the filter body 16. Although a threaded coupling can be preferable due to durability, it is contemplated that the elongate body and filter body can be removably coupled by any suitable connection that forms a liquid-tight seal between the elongate body and the filter body when in use. Such liquid-tight connectors and fittings are well-known in the art and are not described in detail herein. Such connections can optionally make use of gaskets or other sealing elements to maintain a liquid seal during use.

To clean the utensil, the elongate body 14 can be separated from the filter body 16. A brush can then be provided through the lumen of the elongate body, and the filter (e.g., mesh filter) can be rinsed, soaked, or scrubbed, optionally, with soap. It is contemplated that providing the filter body 16 with female threads can enable a larger opening that enables more thorough cleaning (as compared to the filter body being provided with male threads). Optionally, the elongate body 14 can comprise a threaded end component that is welded or otherwise coupled to a tubular component. In further aspects, the elongate body 14 can be coupled together with a tubular component via integral formation as a unitary, monolithic structure.

In some aspects, the elongate body 14 can comprise a top portion 60 (that defines the second end 20) and a bottom portion 62 that is coupled to the top portion. In some optional aspects, the bottom portion can extend parallel or generally parallel to the longitudinal axis 12, and the top portion can extend parallel or generally parallel to a second axis 64 that forms an obtuse angle a (e.g., from about 135 degrees to about 179 degrees, from about 150 degrees to about 175 degrees, from about 160 degrees to about 170 degrees, at least 135 degrees, at least 150 degrees, or at least 165 degrees, or about 165 degrees) with the longitudinal axis. In some aspects, the top portion 60 can be shorter than the bottom portion 62. Optionally, the top portion 60 can be from about 3.5 cm to about 4.5 cm (or about 4 cm) in length along the second axis 64. In some optional aspects, the length of the bottom portion 62 can be from about 8 to about 24 cm, or from 10 cm to 16 cm. Optionally, the top portion 60 and the bottom portion 62 can be coupled together via integral formation as a unitary, monolithic component. For example, the elongate body 14 can comprise a tubular member that is bent to define the top portion 60 and the bottom portion 62. Optionally, a cover 66 can be positioned over the bent portion of the tubular member. The cover 66 can be, for example, a sleeve clamp (e.g., a three-ring clamp, as shown). The cover 66 can be positioned over (e.g., circumferentially surround) the bent portion to structurally support the bent portion. In further aspects, the cover 66 can serve to improve the aesthetics of the drinking utensil 10. In further aspects, the top portion 60 and the bottom portion 62 can couple together via a threaded coupling.

Referring also to FIG. 9, in some aspects, the second end 20 of the elongate body 14 can have an opening 70 having a major dimension 72 and a minor dimension 74. For example, the second end can be pinched to produce the major and minor dimensions of the opening 70. In some aspects, the major dimension 72 can be at least twice the minor dimension 74. For example, the major dimension 72 can be at least 8 mm or at least 9 mm (e.g., about 10.5 mm, or 10.5 mm +/−1 mm, or 10.5 mm, and the minor dimension can be less than 4 mm (e.g., about 3 mm, or about 2.5 mm, or 2.5 mm +/−1 mm, or 2.5 mm). It is contemplated that this pinched end can slow the rate of flow through the drinking utensil to inhibit the user from burning her mouth. Moreover, the pinched end can distribute liquid exiting therethrough across the tongue for an improved user experience.

In some aspects, a sleeve 76 can cover at least a portion of the elongate body 14 (such as, for example, at least a portion of the top portion 60 of the elongate body). For example, the sleeve can extend to or beyond the second end 20 of the elongate body 14 in a direction away from the first end 18. Optionally, when a cover 66 is provided, the sleeve 76 can be positioned between the cover 66 and the second end 20 of the elongate body 14. The sleeve 76 can optionally comprise polymer (e.g., silicone).

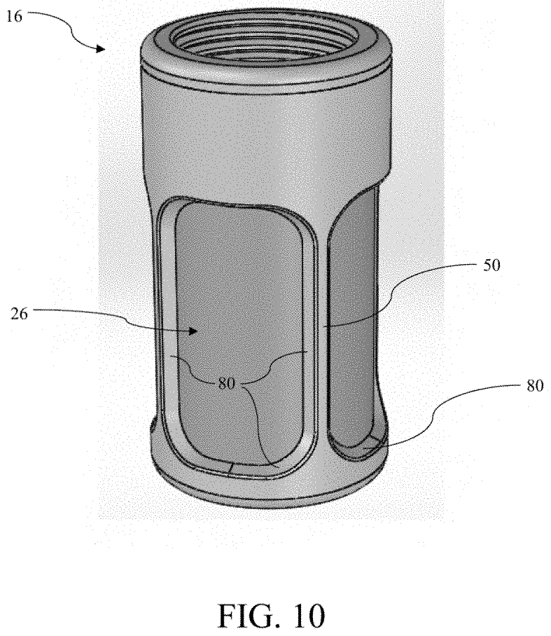

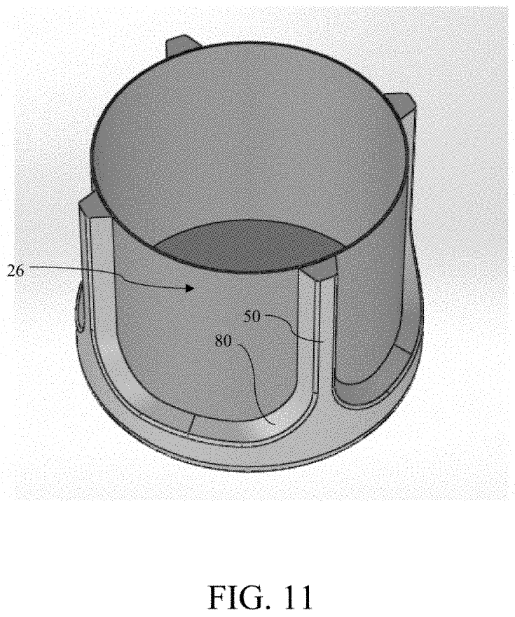

Referring to FIGS. 10-11, in some aspects, one or more (optionally, each) of the side openings 26 can have circumferential edges 80 that are chamfered, such that the dimensions of the opening 26 increase moving radially outwardly. In this way, the longitudinally extending sections 50 can have radial tapers (with a thickness that decreases moving radially outwardly). Similarly, the bottom opening 30 can have a circumferential edge 80 defining a chamfer, with the dimensions of the bottom opening increasing moving radially outwardly. It is contemplated that said chamfered circumferential edges 80 can trap fewer coffee grounds or other solid materials, thereby enabling easier and more thorough cleaning of the filter body 16.

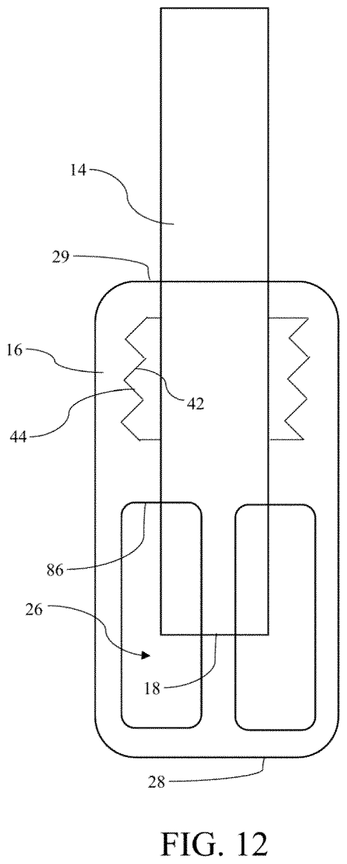

Referring to FIG. 12, in some optional aspects, with the elongate body 14 and the filter body 16 coupled together, the first end 18 of the elongate body 14 can be positioned below an uppermost edge 86 of the openings 26, wherein the uppermost edge 86 is the edge of one or more openings 26 spaced farthest from the bottom surface 28 of the filter housing. In this way, the elongate body 14 can extend into the liquid for sucking the liquid into the elongate body even after the level fluid has dropped below the upper edge of the openings, thereby enabling consumption of a greater quantity of the beverage through the straw than if the first end 18 of the elongate body 14 is above the upper edge 86 of the side openings 26. Optionally, the first end 18 of the elongate body can be positioned at least halfway between the bottom surface 28 and a top end 29 of the filter housing. Optionally, the first end 18 can extend at least 2 mm, at least 5 mm, or at least 1 cm below the upper edge of the side openings 26. In further aspects, the first end 18 of the elongate body 14 can be within no more than 2 mm, no more than 5 mm, no more than 1 cm, or no more than 1.5 cm of the bottom surface 28 of the housing 24.

### EXEMPLARY ASPECTS

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A drinking utensil having a longitudinal axis, the drinking utensil comprising: an elongate body having a first end and an opposing second end spaced from the first end along the longitudinal axis, wherein the elongate body defines a lumen therethrough from the first end to the second end; and a filter body coupled to the first end of the elongate body, wherein the filter body comprises: a housing, wherein the housing defines at least one side opening and a top opening that is in communication with the lumen of the elongate body; and a filter extending across and covering the at least one side opening of the housing.

Aspect 2: The drinking utensil of aspect 1, wherein the elongate body comprises one or more male threads at the first end, wherein the filter body comprises one or more female threads that receive the male threads of the elongate body.

Aspect 3: The drinking utensil of aspect 1, wherein the filter is a mesh filter having a mesh number from 80 mesh to 240 mesh.

Aspect 4: The drinking utensil of aspect 3, wherein the mesh number is from 100 mesh to 150 mesh.

Aspect 5: The drinking utensil of aspect 4, wherein the mesh number is 100 mesh.

Aspect 6: The drinking utensil of any one of the preceding aspects, wherein the filter is slidably received within, and removable from, the housing.

Aspect 7: The drinking utensil of any one of aspects 1-5, wherein the filter is fixedly coupled to the housing.

Aspect 8: The drinking utensil of aspect 7, wherein the filter is welded to the housing.

Aspect 9: The drinking utensil of any one of the preceding aspects, wherein the at least one side opening comprises a plurality of side openings.

Aspect 10: The drinking utensil of aspect 9, wherein the plurality of side openings are circumferentially spaced around the housing about the longitudinal axis.

Aspect 11: The drinking utensil of aspect 9 or aspect 10, wherein the housing defines a respective longitudinally extending section between adjacent side openings of the plurality of side openings, wherein the mesh filter defines a seam that extends parallel or generally parallel to the longitudinal axis, wherein the mesh filter is coupled to the housing so that the seam is disposed behind one of the longitudinally extending sections.

Aspect 12: The drinking utensil of any one of the preceding aspects, wherein the second end of the elongate body defines an opening having a major dimension and a minor dimension, wherein the major dimension is at least twice the minor dimension.

Aspect 13: The drinking utensil of aspect 1, wherein the major dimension of the second end of the elongate body is about 11 mm, and the minor dimension of the second end of the elongate body is about 2.2 mm.

Aspect 14: The drinking utensil of any one of the preceding aspects, wherein the filter body defines at least one bottom opening on a bottom end of the housing opposite the top opening.

Aspect 15: The drinking utensil of aspect 14, wherein the filter extends across the at least one bottom opening.

Aspect 16: The drinking utensil of aspect 14 or aspect 15, wherein the at least one opening at the bottom end of the housing and the at least one side opening cooperate to define an area of at least 300 square millimeters.

Aspect 17: The drinking utensil of aspect 16, wherein the at least one bottom opening at the bottom end of the housing and the at least one side opening cooperate to define an area of at least 400 square millimeters.

Aspect 18: The drinking utensil of any one of the preceding aspects, wherein the housing has a generally cylindrical circumferential surface that has a central axis that is coaxial with the longitudinal axis.

Aspect 19: The drinking utensil of aspect 18, wherein the housing has a bottom surface, wherein the generally cylindrical circumferential surface and the bottom surface intersect at a bottom edge having an outer radius of at least 1 mm and less than 10 mm.

Aspect 20: The drinking utensil of any one of the preceding aspects, wherein the elongate body has a top portion and a bottom portion, wherein the top portion and bottom portion intersect at an obtuse angle.

Aspect 21: The drinking utensil of any one of the preceding aspects, wherein the housing has a bottom surface, wherein the at least one side opening extends no farther than 23 mm from the bottom surface along the longitudinal axis.

Aspect 22: The drinking utensil of aspect 21, wherein the at least one side opening extends no farther than 19 mm from the bottom surface along the longitudinal axis.

Aspect 23: The drinking utensil of any one of the preceding aspects, wherein the at least one side opening is elongate along the longitudinal axis.

Aspect 24: The drinking utensil of any one of the preceding aspects, further comprising a sleeve that extends around at least a portion of the elongate body.

Aspect 25: The drinking utensil of aspect 24, wherein the sleeve comprises silicone.

Aspect 26: The drinking utensil of any one of the preceding aspects, wherein the housing has a length along the longitudinal axis and a width transverse to the longitudinal axis, wherein the length of the housing is greater than the width of the housing.

Aspect 27: A filter body comprising: a housing, wherein the housing defines at least one side opening and a top opening, wherein the top opening is configured to be coupled to an elongate body; and a mesh filter extending across and covering the at least one side opening of the housing.

Aspect 28: The filter body as in aspect 27, wherein the housing defines at least one female thread in communication with the top opening.

Aspect 29: The filter body of aspect 27 or aspect 28, wherein the filter body defines at least one bottom opening on a bottom end of the housing opposite the top opening.

Aspect 30: The filter body of any one of aspects 27-29, wherein the filter extends across the at least one bottom opening.

Aspect 31: The filter body of any one of aspects 27-30, wherein the at least one side opening comprises a plurality of side openings.

Aspect 32: The filter body of aspect 31, wherein the plurality of side openings are circumferentially spaced around the housing about the longitudinal axis.

Aspect 33: The filter body of aspect 31 or aspect 32, wherein the housing defines a respective longitudinally extending section between adjacent side openings of the plurality of side openings, wherein the mesh filter defines a seam that extends parallel or generally parallel to the longitudinal axis, wherein the mesh filter is coupled to the housing so that the seam is disposed behind one of the longitudinally extending sections.

Aspect 34: A method comprising consuming a beverage from a drinking utensil as in any one of aspect 1-26 or 38.

Aspect 35: The method of aspect 34, further comprising: separating the filter body from the elongate body; and cleaning the filter body.

Aspect 36: A filter body as disclosed herein.

Aspect 37: An elongate body as disclosed herein.

Aspect 38: The drinking utensil as in any one of aspects 1-26, wherein at least one of the at least one side opening has an uppermost edge, wherein the first end of the elongate body is spaced from the uppermost edge in a direction away from the second end of the elongate body along the longitudinal axis.

Aspect 39: The drinking utensil as in any one of aspects 1-26 or 38, wherein at least one of the at least one side openings has a circumferential edge defining a chamfer.

Although the foregoing invention has been described in some detail by way of illustration and example for purposes of clarity of understanding, certain changes and modifications may be practiced within the scope of the appended claims.

What is claimed is:

1. A drinking utensil having a longitudinal axis, the drinking utensil comprising:
an elongate body having a first end and an opposing second end spaced from the first end along the longitudinal axis, wherein the elongate body defines a lumen therethrough from the first end to the second end; and
a filter body coupled to the first end of the elongate body, wherein the filter body comprises:
a housing, wherein the housing defines at least one side opening and a top opening that is in communication with the lumen of the elongate body; and
a filter extending across and covering the at least one side opening of the housing.

2. The drinking utensil of claim 1, wherein the elongate body comprises one or more male threads at the first end, wherein the filter body comprises one or more female threads that receive the male threads of the elongate body.

3. The drinking utensil of claim 1, wherein the filter is a mesh filter having a mesh number from 80 mesh to 240 mesh.

4. The drinking utensil of claim 3, wherein the mesh number is from 100 mesh to 150 mesh.

5. The drinking utensil of claim 4, wherein the mesh number is 100 mesh.

6. The drinking utensil of claim 1, wherein the at least one side opening comprises a plurality of side openings, wherein the plurality of side openings are circumferentially spaced around the housing about the longitudinal axis.

7. The drinking utensil of claim 6, wherein the housing defines a respective longitudinally extending section between adjacent side openings of the plurality of side openings, wherein the mesh filter defines a seam that extends parallel or generally parallel to the longitudinal axis, wherein the mesh filter is coupled to the housing so that the seam is disposed behind one of the longitudinally extending sections.

8. The drinking utensil of claim 1, wherein the second end of the elongate body defines an opening having a major dimension and a minor dimension, wherein the major dimension is at least twice the minor dimension.

9. The drinking utensil of claim 1, wherein the major dimension of the second end of the elongate body is about 11 mm, and the minor dimension of the second end of the elongate body is about 2.2 mm.

10. The drinking utensil of claim 1, wherein the filter body defines at least one bottom opening on a bottom end of the housing opposite the top opening, wherein the filter extends across the at least one bottom opening.

11. The drinking utensil of claim 10, wherein the at least one opening at the bottom end of the housing and the at least one side opening cooperate to define an area of at least 300 square millimeters.

12. The drinking utensil of claim 11, wherein the at least one bottom opening at the bottom end of the housing and the at least one side opening cooperate to define an area of at least 400 square millimeters.

13. The drinking utensil of 1, wherein the housing has a generally cylindrical circumferential surface that has a central axis that is coaxial with the longitudinal axis.

14. The drinking utensil of claim 13, wherein the housing has a bottom surface, wherein the generally cylindrical circumferential surface and the bottom surface intersect at a bottom edge having an outer radius of at least 1 mm and less than 10 mm.

15. The drinking utensil of claim 1, wherein the elongate body has a top portion and a bottom portion, wherein the top portion and bottom portion intersect at an obtuse angle.

16. The drinking utensil of claim 1, wherein the housing has a bottom surface, wherein the at least one side opening extends no farther than 23 mm from the bottom surface along the longitudinal axis.

17. The drinking utensil of claim 1, wherein the at least one side opening is elongate along the longitudinal axis.

18. The drinking utensil of claim 1, wherein at least one of the at least one side opening has an uppermost edge, wherein the first end of the elongate body is spaced from the uppermost edge in a direction away from the second end of the elongate body along the longitudinal axis.

19. The drinking utensil of claim 1, wherein at least one of the at least one side openings has a circumferential edge defining a chamfer.

20. A filter body comprising:
a housing, wherein the housing defines at least one side opening and a top opening, wherein the top opening is configured to be coupled to an elongate body; and
a mesh filter extending across and covering the at least one side opening of the housing.
